(19) United States
(12) Patent Application Publication
(10) Pub. No.: US 2025/0065458 A1
(43) Pub. Date: Feb. 27, 2025

(54) MACHINE TOOL

(71) Applicant: INNSE-BERARDI S.P.A. SOCIETA' UNIPERSONALE, Milano (IT)

(72) Inventors: Roberto CODINI, Milano (IT); Franco Giuseppe ADORNI, Milano (IT)

(21) Appl. No.: 18/729,032

(22) PCT Filed: Dec. 15, 2022
(86) PCT No.: PCT/IB2022/062280

§ 371 Date: Jul. 15, 2024

(30) Foreign Application Priority Data
Jan. 25, 2022 (IT) 102022000001247

(51) Int. Cl. B23Q 1/62; B23Q 5/40; B23Q 11/00

(52) U.S. Cl. CPC B23Q 1/626; B23Q 5/40; B23Q 11/0017

(57) ABSTRACT

A machine tool for chip removal processing has an upright, a bench and a machining group. The upright has a prevailing extension along a vertical axis orthogonal to a base plane, a front side lying on a front upright plane and a rear side lying on a rear upright plane. The front and rear sides are connected to each other by a right side and a left side. The bench has a prevailing extension along a longitudinal axis and is suitable to be fixed to the base plane. The machining group, connected to the upright to be translatable along the vertical axis and an advancement axis, is suitable to perform chip removal operations on a workpiece. The upright has a front pair of vertical translation means and a rear pair of vertical translation means that adjust vertical translation of the machining group and keep the machining group orthogonal to the vertical axis.

The present invention relates to the field of machine tools, and in particular to the technical field of large machine tools.

An object of the present invention is a machine tool for chip removal processing, e.g., a drilling machine or a milling-boring machine.

As is well known, the market demand for mechanical components made with increasingly high precision requires the continuously search for new solutions that are capable of satisfying a widespread and far from resolved need. Also in the technical field of large machine tools, the challenge presented by precision mechanics is a driving force for innovation.

Unfortunately, a stable and repeatable technical solution that is capable of ensuring a level of precision of the order of tenths or hundredths of a millimeter in chip removal processing has not been identified yet.

The object of the present invention is to propose a machine tool capable of at least partially overcoming the drawbacks mentioned above.

Said object is achieved with a machine tool according to claim 1. The dependent claims describe preferred embodiments of the invention.

The features and the advantages of the machine tool according to the invention shall be made readily apparent from the following description of preferred embodiment examples thereof, provided purely by way of a non-limiting example, with reference to the accompanying figures, wherein:

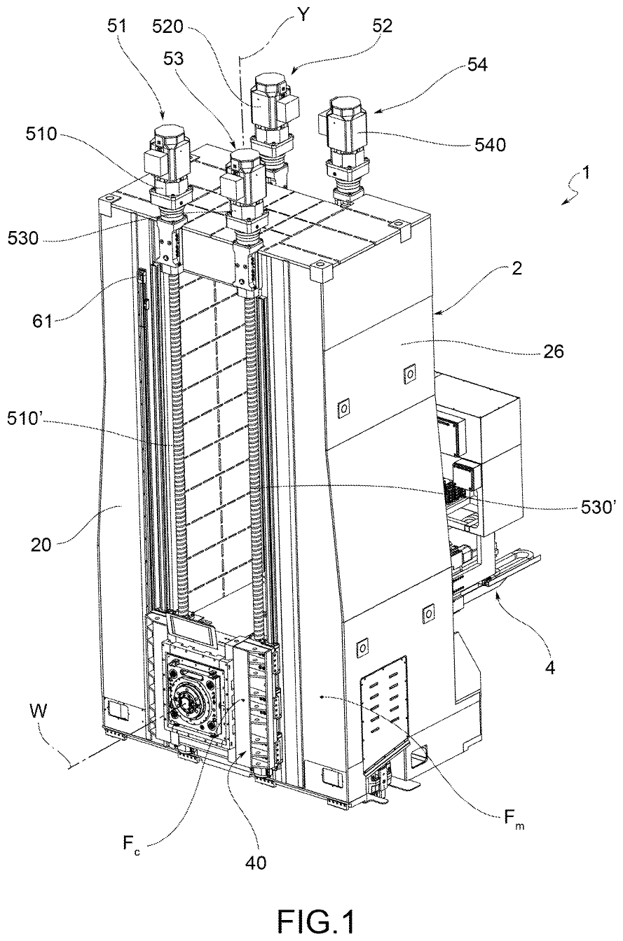

FIG. 1 is a perspective view of a machine tool in one embodiment;

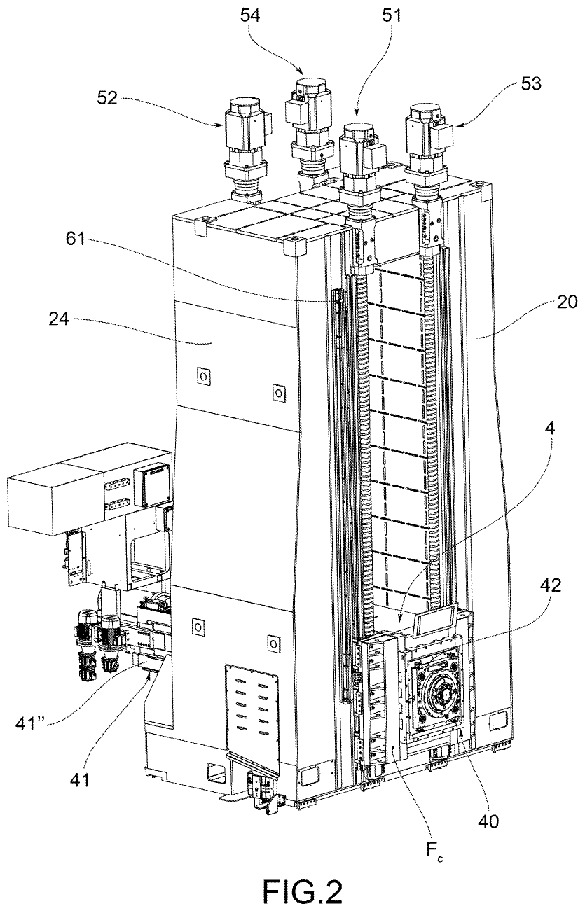

FIG. 2 is a perspective view of the machine tool of FIG. 1 according to a different angle;

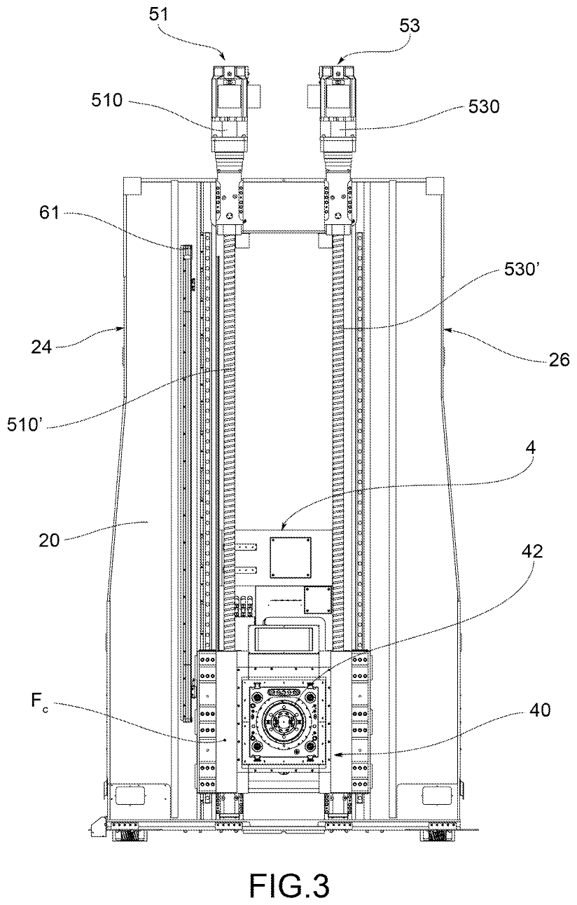

FIG. 3 is a front view of the machine tool of FIG. 1;

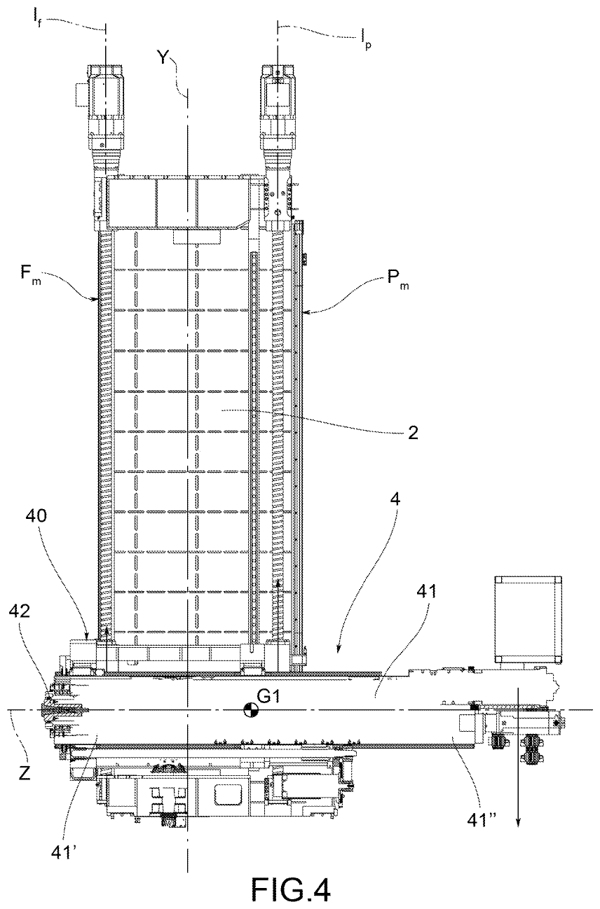

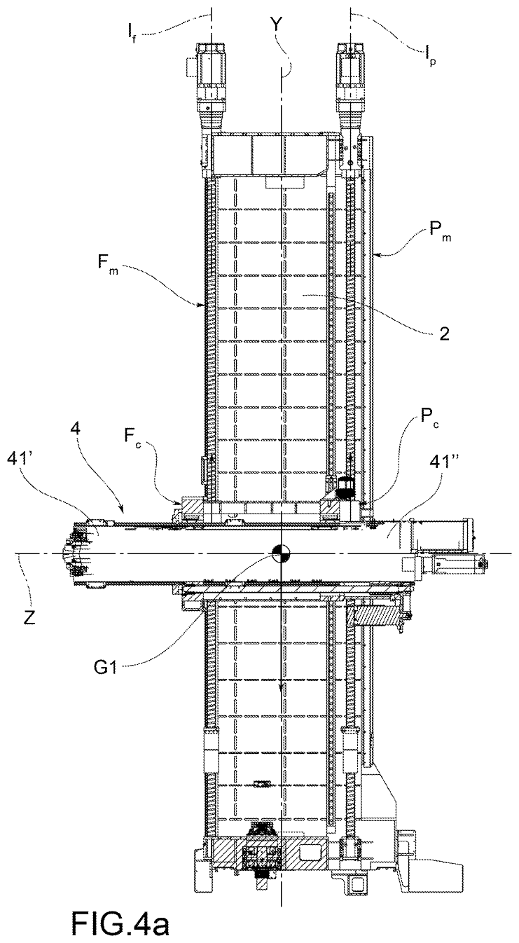

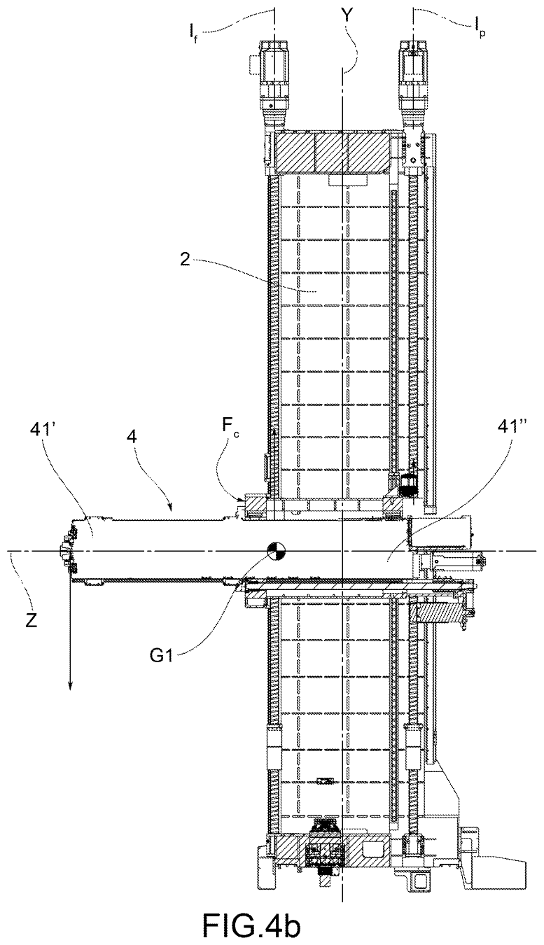

FIG. 4 is a sectional side view of the machine tool in a retracted position;

FIG. 4a is a sectional side view of the machine tool in an intermediate position of equilibrium;

FIG. 4b is a sectional side view of the machine tool in a forward position;

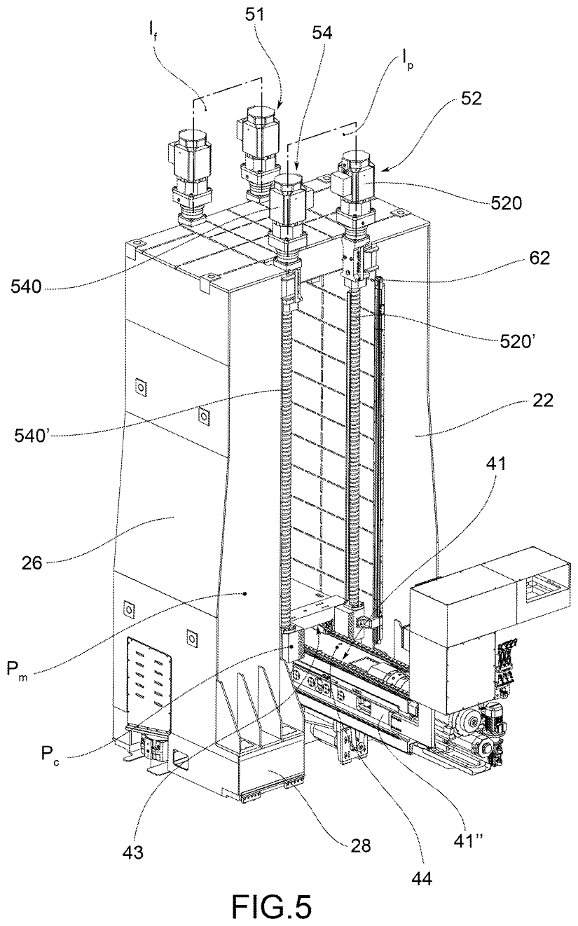

FIG. 5 is a rear perspective view of the machine tool, and

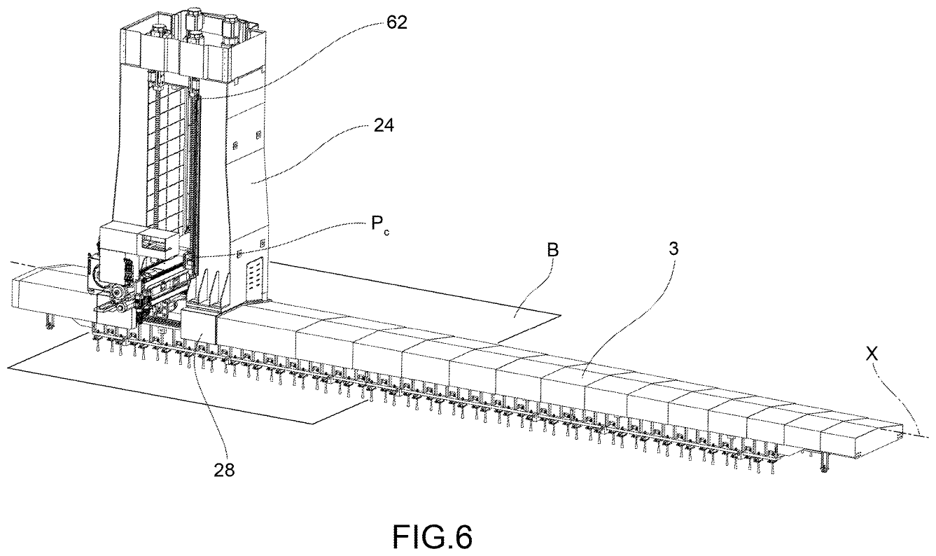

FIG. 6 is a rear perspective view of a further embodiment of the machine tool according to a different angle.

In the following description, elements common to the various embodiments represented in the drawings are indicated with the same reference numerals.

In said drawings, the reference numeral 1 is used to indicate as a whole a machine tool according to the invention.

In a general embodiment the machine tool 1 for chip removal processing operations is, e.g., a drilling machine or a milling-boring machine. Such machine tool 1 comprises an upright 2, a bench 3 and a machining group 4.

The upright 2 has a prevailing extension along a vertical axis Y which is substantially orthogonal to a base plane B suitable for acting as a plane for supporting the machine. The upright 2 has a front side 20 lying on a front upright plane Fm and a rear side 22 lying on a rear upright plane Pm. The front side 20 and the rear side 22 are connected to each other by a right side 24 and a left side 26. Finally, the upright 2 also comprises a base support 28.

The bench 3 has a prevailing extension along a longitudinal axis X and is suitable to be fixed to the base plane B. Furthermore, the bench is engaged by the base support 28, SO as to make the upright 2 longitudinally translatable along the bench 3.

The machining group 4 is connected to the upright in such a way as to be translatable along the vertical axis Y and along an advancement axis Z that is orthogonal to both the vertical axis Y and the longitudinal axis X. Such a machining group is suitable for performing chip removal operations on a workpiece.

Preferably, the machining group 4 has a prevailing extension along the advancement axis Z.

According to the invention, the upright 2 comprises a front pair of vertical translation means 51, 53 and a rear pair of vertical translation means 52, 54 suitable to engage the machining group 4. The front pair of vertical translation means 51, 53 and the rear pair of vertical translation means 52, 54 adjust the vertical translation of machining group 4 and keep the machining group orthogonal to the vertical axis Y.

According to an embodiment, the machining group 4 comprises a carriage 40 and a slide 41.

The carriage 40 is delimited by a front end engaged to the front pair of vertical translation means 51, 53, and a rear end engaged to the rear pair of vertical translation means 52, 54 so as to translate vertically along the vertical axis Y. The front end lies on a front carriage plane Fc and the rear end lies on a rear carriage plane Pc.

The slide 41, preferably a RAM slide, is housed in the carriage 40 in such a way as to translate along the advancement axis Z. This slide 41 comprises a tool-holder table 42 which is preferably provided with a spindle rotatable relative to a machining axis W.

The tool-holder table 42 is further suitable to house a machining tool. In particular, such a machining tool may be installed on the rotating spindle.

The translation along the advancement axis Z of the slide relative to the carriage horizontally displaces the position of a center of gravity G1 of the machining group 4. This center of gravity G1 of the machining group 4 is positioned between an imaginary front plane If, which connects the front pair of vertical translation means 51, 53, and an imaginary rear plane Ip, which connects the rear pair of vertical translation means 52, 54.

The front pair of vertical translation means 51, 53 and the rear pair of vertical translation means 52, 54 keep the carriage front plane Fc parallel to the front upright plane Fm independently of the position of the center of gravity G1 of machining group 4.

For the purposes of this discussion, the term “front” and the respective derivatives thereof is to be understood as an element that is facing (or at least near to) the workpiece; while the term “rear” and the respective derivatives thereof refer to an element positioned distally or in any case on an opposite side relative to the workpiece.

In this description, the terms “above”, “top” and the respective derivatives thereof refer to the machine tool in an operating condition. Similarly, the terms “under”, “bottom” and the respective derivatives thereof also refer to the machine tool that is installed and in operation.

Preferably, a skilled person may also identify the slide 41 using the name “head” or “RAM”. The slide 41 runs inside the carriage 40 along the advancement axis Z and is connected to the carriage 40 by means of a pair of upper carriages 43 and a pair of lower carriages. The pair of upper carriages 43 is arranged on an upper face 44 of the slide 41, whilst the pair of lower carriages is arranged on a lower face of the slide 41.

In addition, the slide 41 extends between a front slide end 41′, where the tool-holder r table 42 is arranged, and a rear slide end 41″.

In detail, when the slide 41 translates inside the carriage 40 along the advancement axis Z, the position of the center of gravity G1 of the machining group 4 moves along such an advancement axis Z. In other words, the position of the center of gravity G1 changes as a function of the position of the slide 41 relative to the carriage 40. Therefore, due to the elasticity of the components of the machine tool 1, the change in position of the center of gravity G1 changes the attitude of machining group 4 relative to the upright 2. The change in the attitude of the machining group 4 due to the displacement of the center of gravity G1 is to the detriment of precision mechanics.

Operationally, in order to compensate for variations in the attitude of the machining group 4 and to comply with the dimensional requirements imposed by precision mechanics, the front pair of vertical translation means 51, 53 cooperates with the rear pair of vertical translation means 52, 54 in order to keep the machining group 4 orthogonal to the vertical axis Y, independently of the position of the center of gravity G1.

According to one embodiment, the front pair of vertical translation means 51, 53 comprises a front pair of actuating gear motors 510, 530 and a front pair of ball screws 510′, 530′.

A first gear motor 510 of the front pair of actuating gear motors 510, 530 actuates a first ball screw 510′ of the front pair of ball screws 510′, 530′.

A second gear motor 530 of the front pair of actuating gear motors 510, 530 actuates a second ball screw 530′ of the front pair of ball screws 510′, 530′.

According to an embodiment, the first gear motor is the master and the second gear motor is the slave. In other words, the front pair of actuating gear motors 510, 530 has a master-slave architecture.

According to an embodiment, the rear pair of vertical translation means 52, 54 comprises a rear pair of actuating gear motors 520, 540 and a rear pair of ball screws 520′, 540′.

A third gear motor 520 of the rear pair of actuating gear motors 520, 540 actuates a third ball screw 520′ of the rear pair of ball screws 520′, 540′.

A fourth gear motor 540 of the rear pair of actuating gear motors 520, 540 actuates a fourth ball screw 540′ of the rear pair of ball screws 520′, 540′.

According to an embodiment, the third gear motor is the master and the second gear motor is the slave. In other words, the rear pair of actuating gear motors 520, 540 has a master-slave architecture.

In an embodiment, the first gear motor 510 is the master relative to the third gear motor 520, so as to make the rear pair of vertical translation means 52, 54 the slave relative to the first gear motor 510.

Alternatively, the third gear motor 520 is the master relative to the first gear motor 510, so as to make the front pair of vertical translation means 51, 53 the slave relative to the third gear motor 520.

According to an embodiment, a GANTRY control is provided between each master and the respective slaves.

Thus, there is a GANTRY control both on the front pair of actuating gear motors 510, 530 and on the rear pair of actuating gear motors 520, 540.

Furthermore, a GANTRY control is also provided between the front pair of actuating gear motors 510, 530 and the rear pair of actuating gear motors 520, 540. In particular, when the first gear motor 510 is the master relative to the third gear motor 520 or when the third gear motor 520 is the master relative to the first gear motor 510.

The GANTRY control is implemented on master-slave architectures wherein, by means of MIMO (Multiple-Input and Multiple-Output) communication, the slave gear motors follow the positions controlled by the master and send the feedback data thereof to the master, so as to obtain closed-loop control.

Preferably, the front pair of actuating gear motors 510, 530 is independent of the rear pair of actuating gear motors 520, 540. This particular configuration is known to the skilled person as “decoupling”, i.e. there is no GANTRY control between the front pair of actuating gear motors 510, 530 and the rear pair of actuating gear motors 520, 540. In other words, the front pair of vertical translation means 51, 53 is completely independent of the rear pair of vertical translation means 52, 54.

According to an embodiment, the slide 41 is movable between a forward position (FIG. 4b) and a retracted position (FIG. 4). In the forward position, the center of gravity G1 of the machining group 4 is near the front imaginary plane If and the tool-holder table 42 tends to bend downward. In the retracted position, the center of gravity G1 of the machining group 4 is near the imaginary rear plane Ip and the tool-holder table 42 tends to bend upward.

Between the forward position and the retracted position there is an intermediate equilibrium position (FIG. 4a), wherein the center of gravity G1 of the machining group 4 is at an intermediate position between the front imaginary plane If and the rear imaginary plane Ip so that the front carriage plane Fc is parallel to the front upright plane Fm and the force applied by the front pair of vertical translation means 51, 53 is essentially coincident with the force applied by the rear pair of vertical translation means 52, 54.

In accordance with the attached FIGS. 4-4b, where the carriage 40 engages with the front pair of ball screws 510′, 530′ and where the carriage 40 engages with the rear pair of ball screws 520′, 540′, directional arrows pointing upwards have been represented graphically indicating the forces wherewith the front pair of vertical translation means 51, 53 and the rear pair of vertical translation means 52, 54 pull the machining group 4 upward, so as to recover the attitude of the machining group due to the displacement of the center of gravity G1. The length of the arrows, although not to scale, is indicative of the intensity of the force wherewith the front pair of vertical translation means 51, 53 and the rear pair of vertical translation means 52, 54 pull the machining group 4 upwards.

FIG. 4 shows the slide 41 in the retracted position, wherein the rear slide end 41″ tends to bend downwards and therefore the force wherewith the rear pair of vertical translation means 52, 54 pulls the machining group 4 upwards is greater than the force applied by the front pair of vertical translation means 51, 53.

FIG. 4a shows the slide 41 in an intermediate equilibrium position, wherein the force applied by the front pair of vertical translation means 51, 53 is substantially coincident with the force applied by the rear pair of vertical translation means 52, 54.

Figure shows the slide 41 in the forward position, wherein the front slide end 41′ tends to bend downward and therefore the force wherewith the front pair of vertical translation means 51, 53 pulls the machining group 4 upwards is greater than the force applied by the rear pair of vertical translation means 52, 54.

Preferably, the displacement of the center of gravity G1, i.e. the displacement of the center of gravity G1 along the advancement axis Z, is comprised between the imaginary front plane If and the imaginary rear plane Ip, so that the forces applied by the front pair of vertical translation means 51, 53 and by the rear pair of vertical translation means 52, 54 are always directed upwards. This constraint on the excursion of the center of gravity G1 is due to the fact that if the center of gravity G1 frontly exceeded the imaginary front plane If (or posteriorly exceeded the imaginary rear plane Ip), the force applied by the rear pair of vertical translation means 52, 54 (or by the front pair of vertical translation means 51, 53) would undergo a reversal in direction and would therefore be turned downwards. It has been experimentally observed that a change in direction of the force applied to the carriage 40 by the rear pair of vertical translation means 52, 54 (or by the front pair of vertical translation means 51, 53) results in a situation of instability for the machine tool.

According to an embodiment, in the forward position, the front pair of vertical translation means 51, 53 apply a force directed upwards which is greater than the one applied by the rear pair of vertical translation means 52, 54, so as to restore parallelism between the front carriage plane Fc and the front upright plane Fm. In particular, such a front pair of vertical translation means 51, 53 counteract the downward bending of the tool-holder table 42 by vertically translating the carriage upwards with a front force which is greater than the rear force with which the rear pair of vertical translation means 52, 54 vertically translate the carriage upwards.

In accordance with an embodiment, in the retracted position, the front pair of vertical translation means 51, 53 apply a force directed upwards which is smaller than the one applied by the rear pair of vertical translation means 52, 54, so as to restore parallelism between the front carriage plane Fc and the front upright plane Fm. In particular, such a front pair of vertical translation means 51, 53 counteract the upward bending of the tool-holder table 42 by vertically translating the carriage upwards with a front force which is smaller than the rear force with which the rear pair of vertical translation means 52, 54 vertically translate the carriage upwards.

According to an embodiment, the machine tool 1 comprises a first position sensor 61, e.g., a first optical scale, for controlling the positioning of the front pair of vertical translation means 51, 53.

In one embodiment, the machine tool 1 comprises a second position sensor 62, e.g., a second optical scale, for controlling the positioning of the rear pair of vertical translation means 52, 54.

In accordance with an embodiment, in the machine tool 1 there is a control unit configured to manage the open-loop operation of the machine, insofar as the every position of the slide 41 has been tested. The control unit controls the movement of the front pair of vertical translation means 51, 53 and the rear pair of vertical translation means 52, 54, so as to keep the front carriage plane Fc always parallel to the front upright plane Fm. In particular, the machine tool 1 has been tested to perform the mapping of each position of the slide 41, wherein at each point of the slide the inclination of the tool-holder table 42 has been measured and the intensity of the front force that the front pair of vertical translation means 51, 53 must apply and the intensity of the rear force that the rear pair of vertical translation means 52, 54 must apply has been defined, so as to always keep the front carriage plane Fc parallel to the front upright plane Fm.

According to an embodiment, in the machine tool 1 there is a control unit configured to manage the closed-loop operation of the machine. The control unit, in receiving position signals from the first and from the second optical scale, is configured to adjust the movement of the front pair of vertical translation means 51, 53 and of the rear pair of vertical translation means 52, 54, so as to keep the front carriage plane Fc always parallel to the front upright plane Fm. In other words, the first and second optical scales provide actual dimensions regarding the position of the slide 41 and the control unit compares the actual dimensions with the theoretical dimensions of the slide and imposes a pulling force on the front pair of vertical translation means 51, 53 and on the rear pair of vertical translation means 52, 54, so as to always keep the front carriage plane Fc parallel to the front upright plane Fm.

Innovatively, the machine tool covered by this patent application fulfills the intended purpose thereof.

Advantageously, the machine tool, object of the present application, may also be used for precision mechanics.

According to an advantageous aspect, the machine tool, object of the present application, allows for immediate compensation of the attitude of the machining group.

To the embodiments of the machine tool according to the invention, a person skilled in the art, in order to meet contingent needs, may make modifications, adaptations and replacements of elements with functionally equivalent ones, without leaving the scope of protection of the following claims. Each of the features described as belonging to a possible embodiment may be obtained independently of the other described embodiments.

1. A machine tool for chip removal processing, comprising:
an upright having a prevailing extension along a vertical axis substantially orthogonal to a base plane for supporting the machine tool, wherein the upright comprises a front side lying on a front upright plane and a rear side lying on a rear upright plane, said front side and said rear side being connected to each other by a right side and a left side, the upright further comprising a base support;
a bench having a prevailing extension along a longitudinal axis and being suitable to be fixed to the base plane, said bench being further engaged by the base support, so as to make the upright longitudinally translatable on the bench; and
a machining group connected to the upright to be translatable along the vertical axis and along an advancement axis orthogonal to both the vertical axis and the longitudinal axis, said machining group being suitable to perform chip removal operations on a workpiece,
wherein the upright further comprises a front pair of vertical translation means and a rear pair of vertical translation means suitable to engage the machining group, and wherein
the front pair of vertical translation means and the rear pair of vertical translation means adjust a vertical translation of the machining group and keep the machining group orthogonal to the vertical axis.

2. The machine tool of claim 1, wherein the machining group comprises:
a carriage delimited by a front end engaged to the front pair of vertical translation means and a rear end engaged to the rear pair of vertical translation means so as to translate vertically along the vertical axis, said front end lying on a carriage front plane and said rear end lying on a carriage rear plane;
a slide housed in the carriage to translate along the advancement axis, said slide comprising a tool-holder table, the tool-holder table being suitable to house a machining tool,
wherein a translation along the advancement axis of the slide relative to the carriage horizontally displaces a position of a center of gravity of the machining group, the center of gravity of the machining group being positioned between an imaginary front plane that connects the front pair of vertical translation means, and an imaginary rear plane that connects the rear pair of vertical translation means, and
wherein the front pair of vertical translation means and the rear pair of vertical translation means keep the carriage front plane parallel to the front upright plane independently of the position of the center of gravity of the machining group.

3. The machine tool of claim 1, wherein the front pair of vertical translation means comprises a front pair of actuating gear motors and a front pair of ball screws, and wherein a first gear motor of the front pair of actuating gear motors actuates a first ball screw of the front pair of ball screws and a second gear motor of the front pair of actuating gear motors actuates a second ball screw of the front pair of ball screws.

4. The machine tool of claim 3, wherein the first gear motor is a master motor and the second gear motor is a slave motor.

5. The machine tool of claim 1, wherein the rear pair of vertical translation means comprises a rear pair of actuating gear motors and a rear pair of ball screws, and wherein a third gear motor of the rear pair of actuating gear motors actuates a third ball screw of the rear pair of ball screws and a fourth gear motor of the rear pair of actuating gear motors actuates a fourth ball screw of the rear pair of ball screws.

6. The machine tool of claim 5, wherein the third gear motor is a master motor and the fourth gear motor is a slave motor.

7. The machine tool of claim 6, wherein the front pair of vertical translation means comprises a front pair of actuating gear motors and a front pair of ball screws, wherein a first gear motor of the front pair of actuating gear motors actuates a first ball screw of the front pair of ball screws and a second gear motor of the front pair of actuating gear motors actuates a second ball screw of the front pair of ball screws, wherein the first gear motor is a master motor and the second gear motor is a slave motor, and wherein the first gear motor is the master motor relative to the third gear motor, so as to make the rear pair of vertical translation means slave relative to the first gear motor.

8. The machine tool of claim 2, wherein the slide is movable between a forward position in which the center of gravity of the machining group is near the imaginary front plane and the tool-holder table tends to bend downward, and a retracted position in which the center of gravity of the machining group is near the imaginary rear plane and the tool-holder table tends to bend upward, and wherein between the forward position and the retracted position there is an intermediate equilibrium position in which the center of gravity the machining group is at an intermediate position between the imaginary front plane and the imaginary rear plane so that the carriage front plane is parallel to the front upright plane and a force applied by the front pair of vertical translation means is substantially coincident with a force applied by the rear pair of vertical translation means.

9. The machine tool of claim 8, wherein, in the forward position, the front pair of vertical translation means apply applies a force directed upwards which is greater than the one applied by the rear pair of vertical translation means so as to restore a parallelism between the carriage front plane and the front upright plane.

10. The machine tool of claim 8, wherein, in the retracted position, the front pair of vertical translation means applies a force directed upwards which is smaller than the one applied by the rear pair of vertical translation means so as to restore a parallelism between the front plane of the carriage front plane and the front upright plane.

11. The machine tool of claim 1, further comprising a first position sensor, the first position sensor optionally being a first optical scale, for controlling positioning of the front pair of vertical translation means.

12. The machine tool claim 11, further comprising a second position sensor, the second position sensor optionally being a second optical scale, for controlling positioning of the rear pair of vertical translation means.

13. The machine tool claim 8, further comprising a control unit configured to manage an open-loop operation of the machine tool, wherein, each position of the slide having been tested, the control unit controls movement of the front pair of vertical translation means and of the rear pair of vertical translation means, so as to keep the carriage front plane always parallel to the front upright plane.

14. The machine tool of claim 12, further comprising a control unit configured to manage a closed-loop operation of the machine tool, wherein the control unit, receiving position signals from the first and second optical scales, is further configured to adjust movement of the front pair of vertical translation means and of the rear pair of vertical translation means, so as to keep the carriage front plane always parallel to the front upright plane.

15. The machine tool of claim 1, wherein said machine tool is a drilling machine or a milling-boring machine.

16. The machine tool of claim 2, wherein the slide is a ram slide.

17. The machine tool of claim 2, wherein the tool-holder table is provided with a spindle rotatable relative to a machining axis.

18. The machine tool of claim 9, wherein, in the forward position, the front pair of vertical translation means counteracts a downward bending of the tool-holder table by vertically translating the carriage upwards with a front force greater than a rear force with which the rear pair of vertical translation means vertically translates the carriage upwards.

19. The machine tool of claim 10, wherein, in the retracted position, the front pair of vertical translation means counteracts an upward bending of the tool-holder table by vertically translating the carriage upwards with a front force smaller than a rear force with which the rear pair of vertical translation means vertically translate the carriage upwards.
